(19) United States
(12) Patent Application Publication
(10) Pub. No.: US 2022/0266668 A1
(43) Pub. Date: Aug. 25, 2022

(54) POWERTRAIN FOR ELECTRIC VEHICLE

(71) Applicants: Hyundai Motor Company, Seoul (KR); Kia Corporation, Seoul (KR)

(72) Inventors: Hyu Tae SHIM, Hwaseong-si (KR); Jae Hun Jung, Incheon (KR); Jun Seong Kang, Gwacheon-si (KR); Jin Seung Lim, Seoul (KR); Jae Young Jeon, Seongnam-si (KR)

(73) Assignees: Hyundai Motor Company, Seoul (KR); Kia Corporation, Seoul (KR)

(21) Appl. No.: 17/411,729

(22) Filed: Aug. 25, 2021

(30) Foreign Application Priority Data
Feb. 23, 2021 (KR) 10-2021-0024042

(51) Int. Cl. B60K 1/00; B60K 17/08; F16H 3/66

(52) U.S. Cl. CPC B60K 1/00; B60K 17/08; F16H 3/66; F16H 2200/2005; F16H 2200/0034; F16H 2200/2035; F16H 2200/2038; F16H 2200/0039; F16H 2200/2094; F16H 2200/2082; B60K 2001/001; B60L 7/10

(57) ABSTRACT

A powertrain for an electric vehicle may include a motor, a planetary gear set including at least two sun gears, a three-stage pinion having three different diameters and provided as a planetary gear, a planet carrier provided as a rotation axis of the planetary gear and directly connected to a differential case of a differential device, and a ring gear fixed to a transmission housing, and at least two clutches provided to selectively transmit power of the motor to the sun gears of the planetary gear set.

### CROSS REFERENCE TO RELATED APPLICATION

The present application claims priority to Korean Patent Application No. 10-2021-0024042, filed Feb. 23, 2021, the entire contents of which is incorporated herein for all purposes by this reference.

### BACKGROUND OF THE INVENTION

### Field of the invention

The present invention relates to a technology for a powertrain configuration of an electric vehicle and the like

### Description of Related Art

Conventionally, a powertrain of an electric vehicle is configured to decelerate the power of a motor by a simple external gear method and transmit it to a drive wheel. The powertrain includes a minimum 3-axis configuration, and occupies a relatively large amount of space when mounted on a vehicle, which is disadvantageous in securing internal space. Furthermore, in the case of high-performance and large-sized vehicles, it is difficult to meet both acceleration performance and maximum speed performance with only one reduction ratio.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a powertrain for an electric vehicle configured for improving the mountability of a vehicle and securing an internal space of the vehicle with a configuration which is as compact as possible. Furthermore, the powertrain for an electric vehicle can provide a plurality of shifting stages, facilitating easy acceleration performance and maximum speed performance even in high-performance and large-sized vehicles to improve fuel economy.

To solve the objects above, a powertrain for an electric vehicle according to various exemplary embodiments of the present invention includes a motor, a planetary gear set disposed to form a concentric shaft with the motor, and a differential device disposed to form a concentric shaft with the planetary gear set. The planetary gear set includes a first rotation element, a second rotation element, a third rotation element, a fourth rotation element, and a fifth rotation element. The first rotation element and the second rotation element are engaged with the third rotation element, and are selectively connectable to the motor. The fourth rotation element is engaged with the third rotation element and fixed to a transmission housing. The fifth rotation element is directly connected to the differential device. The third rotation element includes a three-stage pinion having three different external diameters.

The first rotation element may be engaged with a maximum end portion having a maximum diameter of the three-stage pinion, and the first rotation element may be selectively connectable to the motor by a first clutch.

The second rotation element may be engaged with a medium end portion having a medium diameter of the three-stage pinion, and the second rotation element may be selectively connectable to the motor by a second clutch.

The fourth rotation element may be engaged with a minimum end portion having a minimum diameter of the three-stage pinion, and the fifth rotation element may be directly connected to a differential case of the differential device.

One of driveshafts connected to the differential device may be coupled through a center portion of a rotation axis of the motor.

The planetary gear set may further include a sixth rotation element engaged with the third rotation element and selectively connectable to the motor.

The first rotation element may be engaged with a maximum end portion having a maximum diameter of the three-stage pinion, and the first rotation element may be selectively connectable to the motor by a first clutch.

The second rotation element may be engaged with a medium end portion having a medium diameter of the three-stage pinion, and the second rotation element may be selectively connectable to the motor by a second clutch.

The fourth rotation element and the sixth rotation element may be each engaged with a minimum end portion having a minimum diameter of the three-stage pinion, the sixth rotation element may be selectively connectable to the motor by a third clutch, and the fifth rotation element may be directly connected to a differential case of the differential device.

The first rotation element may be engaged with a maximum end portion having a maximum diameter of the three-stage pinion, and the first rotation element may be selectively connectable to the motor by a one-way clutch and a dog clutch.

Furthermore, to solve the problems above, a powertrain for an electric vehicle according to various exemplary embodiments of the present invention includes a motor, a planetary gear set including at least two sun gears, a three-stage pinion having three different diameters and serving as a planetary gear, a planet carrier serving as a rotation axis of the planetary gear and directly connected to a differential case of a differential device, and a ring gear fixed to a transmission housing, and at least two clutches provided to selectively transmit power of the motor to the sun gears of the planetary gear set.

The three-stage pinion may have a minimum end portion having a minimum diameter, a medium end portion having a medium diameter, and a maximum end portion having a maximum diameter, and the ring gear may be engaged with the minimum end portion of the three-stage pinion.

The sun gear may include a first sun gear engaged with the maximum end portion of the three-stage pinion and a second sun gear engaged with the medium end portion.

The first sun gear may be selectively connectable to the motor by a first clutch, and the second sun gear may be selectively connectable to the motor by a second clutch.

The sun gear may include a first sun gear engaged with the maximum end portion of the three-stage pinion, a second sun gear engaged with the middle end portion, and a third sun gear engaged with the minimum end portion. The first sun gear may be selectively connectable to the motor by a first clutch, the second sun gear may be selectively connectable to the motor by a second clutch, and the third sun gear may be selectively connectable to the motor by a third clutch.

The sun gear may include a first sun gear engaged with the maximum end portion of the three-stage pinion and a second sun gear engaged with the medium end portion. The first sun gear may be selectively connectable to the motor by a one-way clutch and a dog clutch, and the second sun gear may be selectively connectable to the motor by a second clutch.

The sun gear may include a first sun gear engaged with the maximum end portion of the three-stage pinion, a second sun gear engaged with the middle end portion, and a third sun gear engaged with the minimum end portion. The first sun gear may be selectively connectable to the motor by a one-way clutch and a dog clutch, the second sun gear may be selectively connectable to the motor by a second clutch, and the third sun gear may be selectively connectable to the motor by a third clutch.

One of driveshafts connected to the differential device may be coupled through a center portion of a rotation axis of the motor.

According to various exemplary embodiments of the present invention, the mountability of a vehicle may be improved with a configuration which is as compact as possible, which is advantageous in securing an internal space. Furthermore, in high-performance and large-sized vehicle, acceleration performance and maximum speed performance may be easily implemented by providing multiple shifting stages, which can improve fuel economy.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram showing various exemplary embodiments of a powertrain for an electric vehicle according to various exemplary embodiments of the present invention.

FIG. 2 is a table of operation modes of the various exemplary embodiments.

FIG. 3 is a diagram explaining a state in which the various exemplary embodiments implements a first stage of EV mode.

FIG. 4 is a diagram explaining a state in which the various exemplary embodiments implements a second stage of EV mode.

FIG. 5 is a diagram showing various exemplary embodiments of a powertrain for an electric vehicle according to various exemplary embodiments of the present invention.

FIG. 6 is a table of operation modes of the various exemplary embodiments.

FIG. 7 is a diagram showing various exemplary embodiments of a powertrain for an electric vehicle according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Specific structural or functional descriptions of the exemplary embodiments of the present invention disclosed in the exemplary embodiment or application are exemplified only for the purpose of describing the exemplary embodiments according to various exemplary embodiments of the present invention. The exemplary embodiments according to various exemplary embodiments of the present invention may be implemented in various forms, and should not be construed as being limited to the exemplary embodiments described in the exemplary embodiment or application.

Since the exemplary embodiments according to various exemplary embodiments of the present invention may be modified in various ways and have various forms, specific embodiments will be illustrated in the drawings and described in detail in the exemplary embodiment or application. However, this is not intended to limit the exemplary embodiments according to the concept of the present invention to a specific form of disclosure, and it should be understood that all changes, equivalents, and substitutes included in the spirit and scope of the present invention are included.

Terms such as first and/or second may be used to describe various components, but the components should not be limited by the terms. The above terms are only for the purpose of distinguishing one component from other components. For example, without departing from the scope of the rights according to the concept of the present invention, the first component may be named as the second component, and similarly, the second component may also be referred to as a first component.

When a component is referred to as being “connected” or “contacted” to another component, it should be understood that it may be directly connected or contacted to the other component, but other components may exist in the middle. On the other hand, when a component is referred to as being “directly connected” or “directly contacted” to another component, it should be understood that there is no other component in the middle. Other expressions describing the relationship between components, such as “between” and “just between” or “adjacent to” and “directly adjacent to” should be interpreted as well.

The terms used in the exemplary embodiment are only used to describe specific embodiments, and are not intended to limit the present invention. Singular expressions include plural expressions unless the context clearly indicates otherwise. In the exemplary embodiment, terms such as “comprise” or “have” are intended to designate the presence of a set feature, number, step, action, component, part, or combination thereof, but it is to be understood that the presence or additional possibilities of one or more other features, numbers. steps, actions, components, parts, or combinations thereof are not preliminarily excluded.

Unless otherwise defined, all terms used herein, including technical or scientific terms, have the same meaning as commonly understood by one of ordinary skill in the art to which various exemplary embodiments of the present invention belongs. Terms such as those defined in a commonly used dictionary should be interpreted as having a meaning consistent with the meaning of the related technology, and should not be interpreted as an ideal or excessively formal meaning unless explicitly defined in the exemplary embodiment of the present invention.

Hereinafter, the present invention will be described in detail by describing various exemplary embodiments of the present invention with reference to the accompanying drawings. The same reference numerals shown in each drawing indicate the same members.

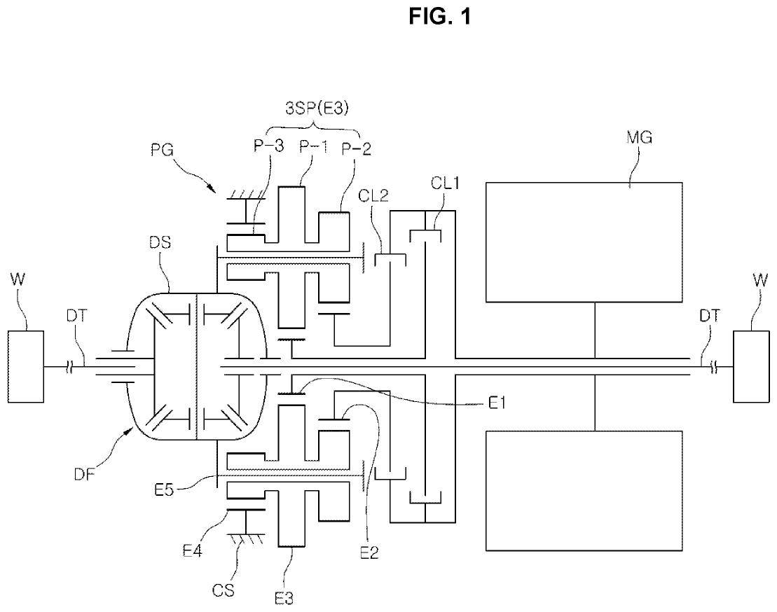

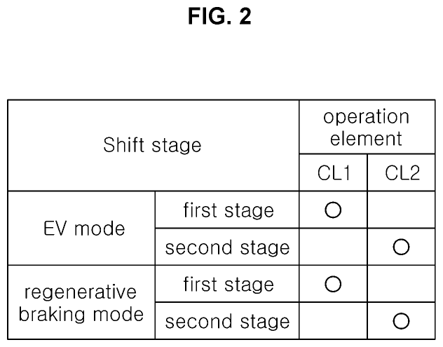

Referring to FIG. 1 and FIG. 2, various exemplary embodiments of a powertrain for an electric vehicle according to various exemplary embodiments of the present invention includes a motor MG, a planetary gear set PG disposed to form a concentric shaft with the motor MG, and a differential device DF disposed to form a concentric shaft with the planetary gear set PG. The planetary gear set PG includes a first rotation element E1, a second rotation element E2, a third rotation element E3, a fourth rotation element E4, and a fifth rotation element E5.

Here, the first rotation element E1 and the second rotation element E2 are engaged with the third rotation element E3 and are selectively connectable to the motor MG. The fourth rotation element E4 is engaged with the third rotation element E3 and fixed to a transmission housing CS. The fifth rotation element E5 is directly connected to the differential device DF. The third rotation element E3 includes a three-stage pinion 3 SP having three different external diameters.

That is, in the exemplary embodiment of the present invention, the three-stage pinion 3SP, which is the third rotation element E3, serves as a planetary gear of the planetary gear set PG, the first rotation element E1 and the second rotation element E2 each serves as a first sun gear and a second sun gear, the fourth rotation element E4 serves as a fixed ring gear, and the fifth rotation element E5 serves as a planet carrier.

The first rotation element E1 is engaged with a maximum end portion P-1 having a maximum diameter of the three-stage pinion 3SP. The first rotation element E1 is connected to the motor MG by a first clutch CL1.

The second rotation element E2 is engaged with a medium end portion P-2 having a medium diameter of the three-stage pinion 3SP. The second rotation element E2 is connected to the motor MG by a second clutch CL2.

Furthermore, the fourth rotation element E4 is engaged with a minimum end portion P-3 having a minimum diameter of the three-stage pinion 3 SP. The fifth rotation element E5 is directly connected to the differential case DS of the differential device DF.

Accordingly, the power of the motor MG input to the first rotation element E1 or the second rotation element E2 is respectively decelerated and output to the differential case DS, and the power of the differential device DF is transmitted to the drive wheel W via the driveshaft DT on both sides.

As shown, one of the driveshafts DT connected to the differential device DF is coupled through the center portion of the rotation axis of the motor MG, so that the motor MG, the planetary gear set PG, and the differential device DF may be disposed on a single axis, forming a compact configuration. Accordingly, the present invention is advantageous in securing a vehicle interior space, while implementing at least two or more shift ratios, which is more advantageous in realizing the acceleration performance and the maximum speed performance of the vehicle.

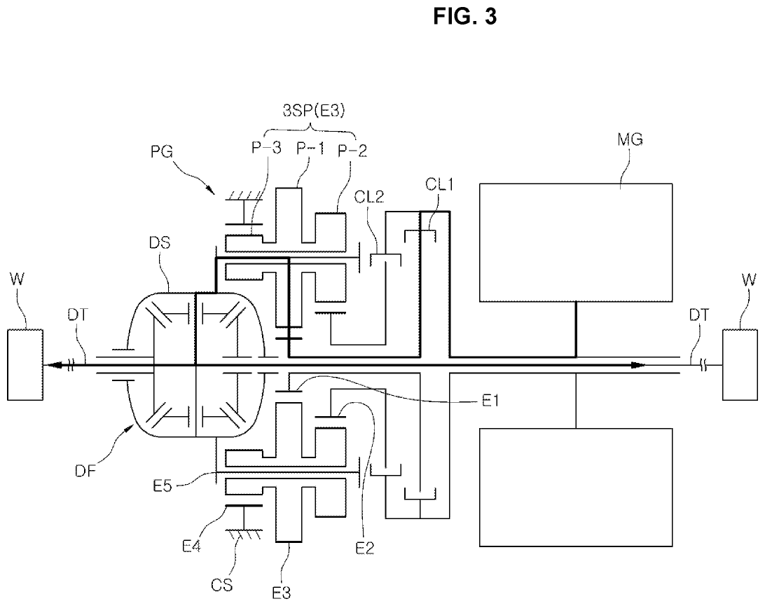

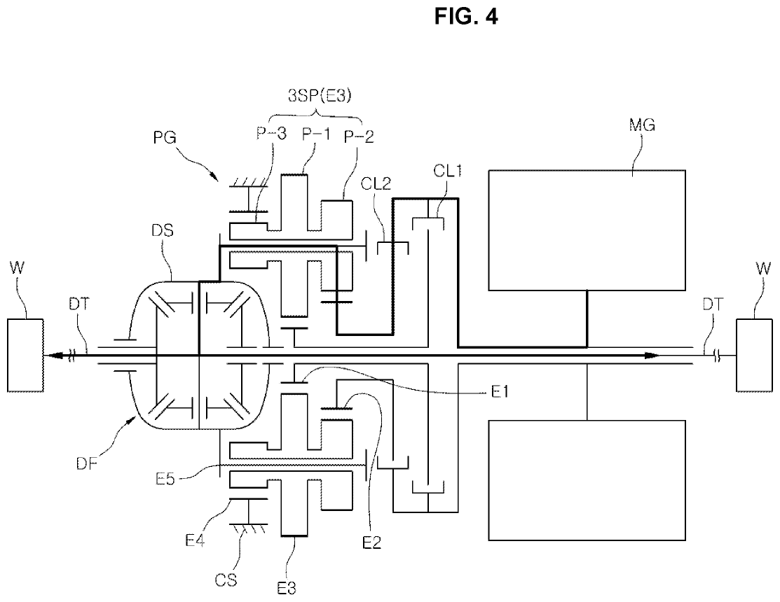

The table of operation modes of the various exemplary embodiments as described above is as shown in FIG. 2. Accordingly, as shown in FIG. 3, the first stage of EV mode is implemented in which the power of the motor MG is transmitted to the planetary gear set PG via the first rotation element E1 and decelerated. As shown in FIG. 4, the second stage of EV mode is implemented in which the power of the motor MG is transmitted to the planetary gear set PG via the second element E2 and decelerated.

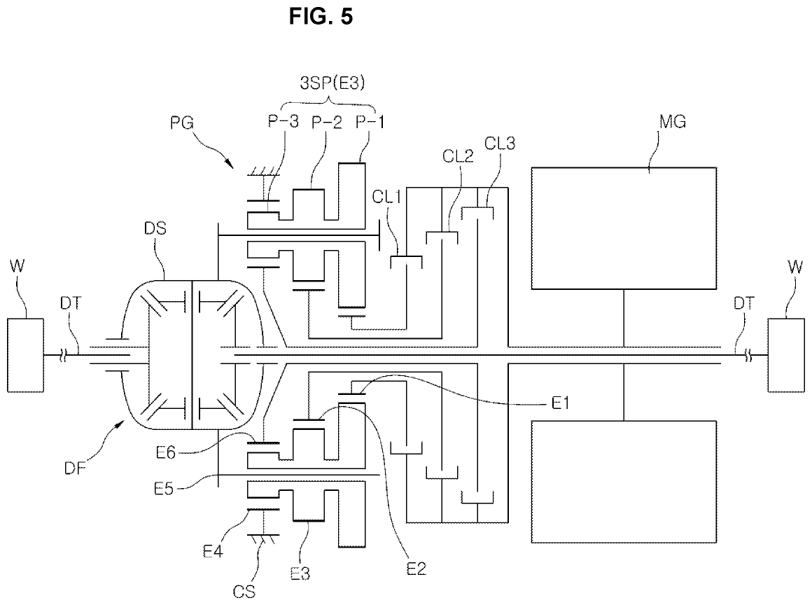

FIG. 5 shows various exemplary embodiments according to various exemplary embodiments of the present invention. The configuration of the various exemplary embodiments is the same as that of the various exemplary embodiments of the present invention in FIG. 1, except that the planetary gear set PG further includes a sixth rotation element E6 engaged with the third rotation element E3 and selectively connectable to the motor MG.

That is, the sixth rotation element E6 is engaged with the minimum end portion P-3 having the minimum diameter of the three-stage pinion 3 SP, together with the fourth rotation element E4, and is connected to the motor MG by a third clutch CL3.

The sixth rotation element E6 may be a third sun gear.

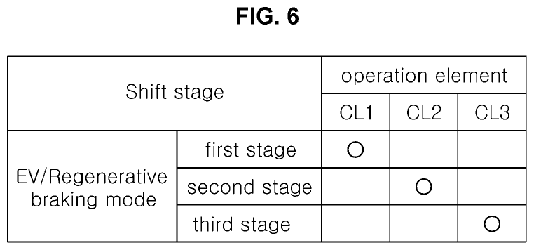

Accordingly, the various exemplary embodiments in FIG. 5 are driven by the table of operation modes as shown in FIG. 6, and can further implement three stages for fastening the third clutch CL3.

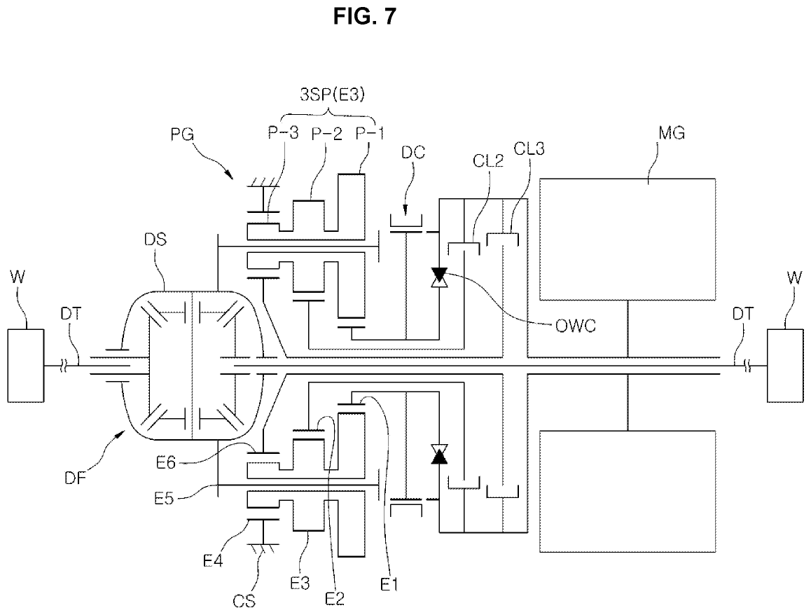

On the other hand, FIG. 7 shows various exemplary embodiments according to various exemplary embodiments of the present invention. The configuration of the third element is the same as that of the various exemplary embodiments of the present invention in FIG. 5, except that instead of the first clutch CL1, the first rotation element E1 is connected to the motor MG by a one-way clutch OWC and a dog clutch DC.

Here, the one-way clutch OWC can transmit power from the motor MG to the first rotation element E1 even when the dog clutch DC is released, and it is provided to cut off power in the opposite direction thereof.

During regenerative braking, the dog clutch DC is fastened. The dog clutch DC may be temporarily fastened to assist the one-way clutch OWC even when driving in the first stage.

As described above, the modification using the dog clutch DC and the one-way clutch OWC instead of the first clutch CL1 may be applied as it is to the case of the various exemplary embodiments.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

Furthermore, the term of “fixedly connected” signifies that fixedly connected members always rotate at a same speed. Furthermore, the term of “selectively connectable” signifies “selectively connectable members rotate separately when the selectively connectable members are not engaged to each other, rotate at a same speed when the selectively connectable members are engaged to each other, and are stationary when at least one of the selectively connectable members is a stationary member and remaining selectively connectable members are engaged to the stationary member”.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A powertrain apparatus for a vehicle, the powertrain apparatus comprising:
a motor;
a planetary gear set concentrically connected to the motor; and
a differential device concentrically connected to the planetary gear set,
wherein the planetary gear set includes a first rotation element, a second rotation element, a third rotation element, a fourth rotation element, and a fifth rotation element,
wherein the first rotation element and the second rotation element are engaged with the third rotation element, and are selectively connectable to the motor,
wherein the fourth rotation element is engaged with the third rotation element and fixed to a transmission housing,
wherein the fifth rotation element is directly connected to the differential device, and
wherein the third rotation element includes a three-stage pinion having three different external diameters.

2. The powertrain apparatus of claim 1,
wherein the three-stage pinion of the third rotation element includes a maximum end portion having a maximum diameter among the three different external diameters, and
wherein the first rotation element is engaged with the maximum end portion of the three-stage pinion, and the first rotation element is selectively connectable to the motor by a first clutch.

3. The powertrain apparatus of claim 2,
wherein the three-stage pinion of the third rotation element further includes a medium end portion having a medium diameter among the three different external diameters, and
wherein the second rotation element is engaged with the medium end portion, and the second rotation element is selectively connectable to the motor by a second clutch.

4. The powertrain apparatus of claim 3,
wherein the three-stage pinion of the third rotation element further includes a minimum end portion having a minimum diameter among the three different external diameters, and
wherein the fourth rotation element is engaged with the minimum end portion, and the fifth rotation element is fixedly connected to a differential case of the differential device.

5. The powertrain apparatus of claim 4, wherein one of driveshafts connected to the differential device is coupled through a center portion of a rotation axis of the motor.

6. The powertrain apparatus of claim 1, wherein the planetary gear set further includes a sixth rotation element engaged with the third rotation element and selectively connectable to the motor.

7. The powertrain apparatus of claim 6,
wherein the three-stage pinion of the third rotation element includes a maximum end portion having a maximum diameter among the three different external diameters, and
wherein the first rotation element is engaged with the maximum end portion, and the first rotation element is selectively connectable to the motor by a first clutch.

8. The powertrain apparatus of claim 7,
wherein the three-stage pinion of the third rotation element further includes a medium end portion having a medium diameter among the three different external diameters, and
wherein the second rotation element is engaged with the medium end portion, and the second rotation element is selectively connectable to the motor by a second clutch.

9. The powertrain apparatus of claim 8, wherein the first rotation element is a first sun gear, the second rotation element is a second sun gear, the fourth rotation element is a ring gear and the fifth rotation element is a planet carrier.

10. The powertrain apparatus of claim 8,
wherein the three-stage pinion of the third rotation element further includes a minimum end portion having a minimum diameter among the three different external diameters,
wherein the fourth rotation element and the sixth rotation element are each engaged with the minimum end portion,
wherein the sixth rotation element is selectively connectable to the motor by a third clutch, and
wherein the fifth rotation element is fixedly connected to a differential case of the differential device.

11. The powertrain apparatus of claim 8, wherein the first rotation element is a first sun gear, the second rotation element is a second sun gear, the fourth rotation element is a ring gear, the fifth rotation element is a planet carrier and the sixth rotation element is a third sun gear.

12. The powertrain apparatus of claim 6,
wherein the three-stage pinion of the third rotation element includes a maximum end portion having a maximum diameter among the three different external diameters, and
wherein the first rotation element is engaged with the maximum end portion, and the first rotation element is selectively connectable to the motor by a one-way clutch and a dog clutch.

13. The powertrain apparatus of claim 11, wherein the one-way clutch and the dog clutch are installed between the first rotation element and the motor in parallel.

14. A powertrain apparatus for a vehicle, the powertrain apparatus comprising:
a motor;
a planetary gear set including:
at least two sun gears, a three-stage pinion having three different diameters and provided as a planetary gear;
a planet carrier provided as a rotation axis of the planetary gear and fixedly connected to a differential case of a differential device; and
a ring gear fixed to a transmission housing; and
at least two clutches provided to selectively transmit power of the motor to the at least two sun gears of the planetary gear set.

15. The powertrain apparatus of claim 14,
wherein the three-stage pinion has a minimum end portion having a minimum diameter among the three different diameters, a medium end portion having a medium diameter among the three different diameters, and a maximum end portion having a maximum diameter among the three different diameters, and
wherein the ring gear is engaged with the minimum end portion of the three-stage pinion.

16. The powertrain apparatus of claim 15,
wherein the at least two sun gears include a first sun gear engaged with the maximum end portion of the three-stage pinion and a second sun gear engaged with the medium end portion of the three-stage pinion,
wherein the at least two clutches includes a first clutch and a second clutch, and
wherein the first sun gear is selectively connectable to the motor by the first clutch, and the second sun gear is selectively connectable to the motor by the second clutch.

17. The powertrain apparatus of claim 15,
wherein the at least two sun gears include a first sun gear engaged with the maximum end portion of the three-stage pinion, a second sun gear engaged with the middle end portion, and a third sun gear engaged with the minimum end portion,
wherein the at least two clutches includes a first clutch, a second clutch and a third clutch, and
wherein the first sun gear is selectively connectable to the motor by the first clutch, the second sun gear is selectively connectable to the motor by the second clutch, and the third sun gear is selectively connectable to the motor by the third clutch.

18. The powertrain apparatus of claim 15,
wherein the at least two sun gears include a first sun gear engaged with the maximum end portion of the three-stage pinion and a second sun gear engaged with the medium end portion of the three-stage pinion,
wherein the at least two clutches includes a one-way clutch, a dog clutch and a second clutch, and
wherein the first sun gear is connected to the motor by the one-way clutch and the dog clutch, and the second sun gear is connected to the motor by the second clutch.

19. The powertrain apparatus of claim 15,
wherein the at least two sun gears include a first sun gear engaged with the maximum end portion of the three-stage pinion, a second sun gear engaged with the middle end portion, and a third sun gear engaged with the minimum end portion,
wherein the at least two clutches includes a one-way clutch, a dog clutch, a second clutch, and a third clutch, and
wherein the first sun gear is selectively connectable to the motor by the one-way clutch and the dog clutch, the second sun gear is selectively connectable to the motor by the second clutch, and the third sun gear is selectively connectable to the motor by the third clutch.

20. The powertrain apparatus of claim 14, wherein one of driveshafts connected to the differential device is coupled through a center portion of a rotation axis of the motor.
